(19) United States
(12) Patent Application Publication
(10) Pub. No.: US 2012/0102908 A1
(43) Pub. Date: May 3, 2012

(54) Rake Along

(76) Inventor: Zacary Gayewski, Burlington, IA (US)

(21) Appl. No.: 13/285,230

(22) Filed: Oct. 31, 2011

Related U.S. Application Data
(60) Provisional application No. 61/408,845, filed on Nov. 1, 2010.

(51) Int. Cl. A01B 1/20; A01B 1/08; A01D 7/00

(52) U.S. Cl. 56/400.06; 56/400.05

(57) ABSTRACT

An architecture is presented that provides a combination tool device or grading device designed for easily and efficiently grading materials used in construction. The combination tool device comprises a handle having a first end and a second end. The combination tool device also comprises a rake and a hoe secured to the first end of the handle. The rake and the hoe are secured on opposite sides of the first end of the handle such that a user can use the shovel-like hoe for pushing and pulling materials around and then turn the handle 180 degrees to use the rake for smoothing materials. Furthermore, when the combination tool device is oriented in an upright position with the second end in the air, the rake and the hoe are positioned to engage the ground and allow the combination tool device to stand upright without support.

### CROSS-REFERENCE

This application claims priority from Provisional Patent Application Serial No. 61/408,845 filed Nov. 1, 2010.

### BACKGROUND

Typically, construction workers are required to level materials used in construction prior to digging leach fields, creating sidewalks, parking lots, or completing other various projects. Similarly, individuals that install and care for lawns and gardens are also oftentimes responsible for leveling the soil prior to installing a lawn or planting or maintaining a garden or crop. To accomplish proper leveling or grading, construction workers and other individuals must use an elongated hoe or come-along tool to push and pull the construction materials, and a forked rake to smooth or otherwise properly position the construction materials, soil, etc. Carrying both of these tools into trenches and then switching back and forth between the tools while working can be laborious and inconvenient. Also, purchasing the tools separately can be expensive. An effective solution is necessary.

Thus, there exists a long-felt need for a grading device that easily and efficiently grades construction materials, soil and the like using a single tool. The present invention discloses a grading or combination tool device that comprises a forked rake and an elongated hoe or come-along tool. The combination tool device allows workers to use one tool to complete a grading job. The combination tool device is able to scratch compacted construction material to make desired changes, and can also break up large chunks of dirt and other construction material.

### SUMMARY

The following presents a simplified summary in order to provide a basic understanding of some aspects of the disclosed innovation. This summary is not an extensive overview, and it is not intended to identify key/critical elements or to delineate the scope thereof Its sole purpose is to present some concepts in a simplified form as a prelude to the more detailed description that is presented later.

The subject matter disclosed and claimed herein, in one aspect thereof, comprises a combination tool device designed for easily and efficiently grading materials used in construction and other settings such as a lawn, field, garden, etc. The combination tool or grading device comprises a handle having a first end and a second end. The combination tool device also comprises a rake and a hoe or relatively flat implement removably secured to the first end of the handle. In the preferred embodiment of the present invention, the rake and the hoe are secured to the first end of the handle such that each of the rake and the hoe face in generally opposite directions so that a user can use the shovel-like hoe for pushing and pulling materials around and then turn the handle generally 180 degrees to use the rake for smoothing materials around. Typically, the rake and the hoe are secured together before securing to the handle though it is also contemplated that the rake and the hoe can be integrally formed or manufactured as a single device.

Furthermore in the preferred embodiment of the present invention, the rake and the hoe are positioned on the handle such that the combination tool device is capable of standing upright on its own. Specifically, the rake is positioned on a first side of the first end of the handle, facing outward from the handle. The hoe is positioned on the side of the first end of the handle opposite the rake, also facing outwardly from the handle. Thus, when the combination tool device is oriented in an upright position with the second end of the handle pointing upward into the air, the rake and the hoe are positioned to engage the ground and allow the combination tool device to stand upright without support.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a combination tool device in accordance with the disclosed architecture.

FIG. 2 illustrates a perspective view of the combination tool device in accordance with the disclosed architecture.

FIG. 3 illustrates a perspective view of the combination tool device in accordance with the disclosed architecture.

FIG. 4 illustrates a perspective view of the combination tool device in an upright position in accordance with the disclosed architecture.

FIG. 5 illustrates a perspective view of the combination tool device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a grading or combination tool device that easily and efficiently grades construction and other materials, such as soil, mulch and the like, using a single tool. The combination tool device comprises a forked rake and an elongated hoe or come-along tool. The combination tool device allows users to utilize the shovel-like come-along side of the device for pushing and pulling construction materials and the like around, and then rotate the handle of the device generally 180 degrees to use the rake side of the device for smoothing the construction materials. The combination tool device is designed for use prior to laying pipe, wire, sidewalks, or for landscaping and other purposes.

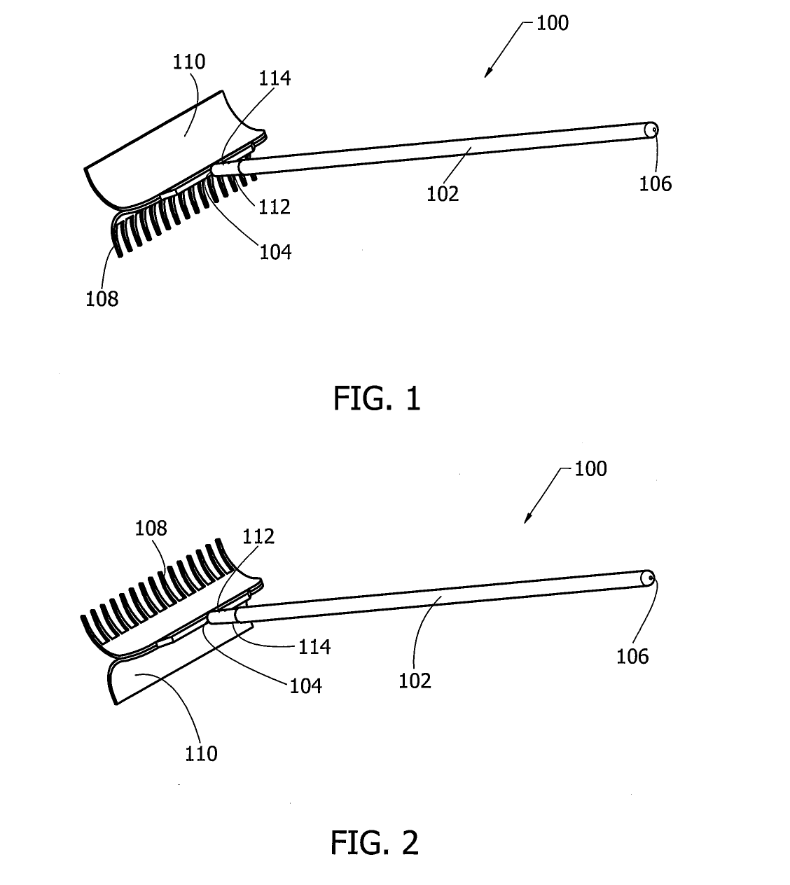

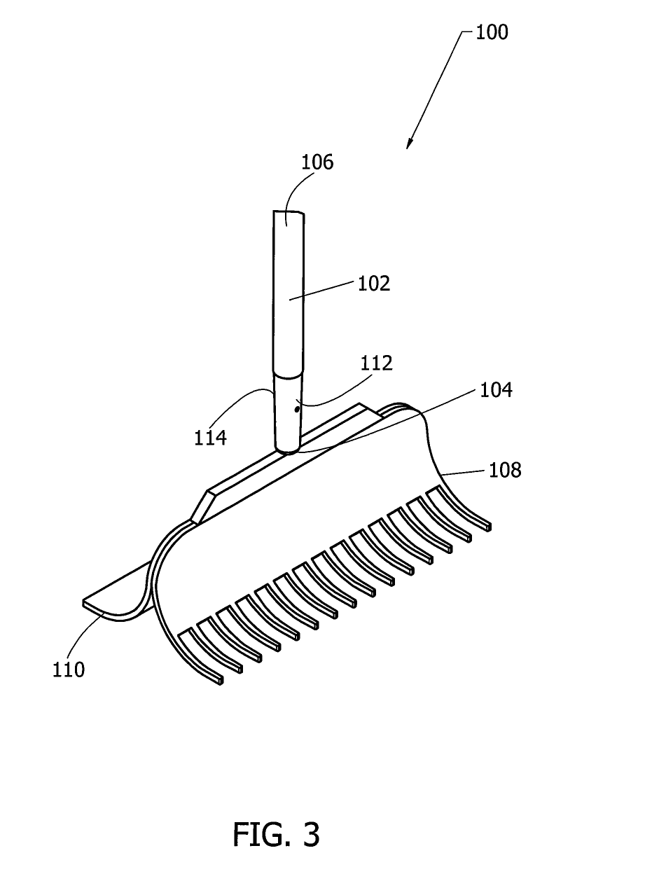

Referring initially to the drawings, FIGS. 1-3 illustrate a combination tool device 100 designed for easily and efficiently grading various materials used in construction and other applications, such as farming, lawn care and gardening. The combination tool device 100 or grading device comprises a handle 102 having a first end 104 and a second end 106. The handle 102 would generally be constructed of aluminum, though any other suitable, highly durable material may be used to manufacture the handle 102 as is known in the art without affecting the overall concept of the invention such as wood, steel, plastic and the like. The handle 102 is approximately between 4.5 to 6.5 inches in diameter, and approximately between 42 to 48 inches long.

Furthermore, the handle 102 is typically cylinder shaped, but can be any suitable shape or size as is known in the art without affecting the overall concept of the invention. The handle 102 is designed to be held by a user (not shown) to push, pull and smooth materials. The handle 102 can be an extended length handle depending on the needs of a user, wherein the handle length is approximately between 48 to 50 inches long. However, the handle 102 can be any suitable length to fit the wants and needs of a user as is known in the art without affecting the overall concept of the invention. Additionally, the handle 102 comprises tools secured to the first end 104.

The tools secured to the first end 104 comprise a rake 108 and a hoe or generally flat implement 110. The rake 108 is typically a steel-forked rake for smoothing materials. However, the rake 108 can be any suitable rake as is known in the art without affecting the overall concept of the invention. The rake 108 is approximately between 19 to 22 inches wide, and approximately between 3 to 6 inches high, and approximately between 3 to 6 inches in depth. The hoe 110 is typically an elongated, shovel-like hoe that is equal in length to the rake 108, for pushing and pulling materials. However, the hoe 110 can be any suitable tool as is known in the art without affecting the overall concept of the invention, such as a come-along tool, a toothless rake, etc. The hoe 110 is approximately between 19 to 22 inches wide, and approximately between 3 to 6 inches high, and approximately between 3 to 6 inches in depth.

Furthermore, the rake 108 and the hoe 110 are removably secured to the first end 104 of the handle 102 in any manner commonly known in the art for attaching an implement or tool head to a handle. The rake 108 and the hoe 110 are secured to the first end 104 of the handle 102 such that each of the rake 108 and the hoe 110 face in generally opposite directions so that a user can use the shovel-like hoe 110 for pushing and pulling materials around and then turn the handle 102 generally 180 degrees to use the rake 108 for smoothing materials around. Specifically, the rake 108 is secured to the first end 104 of the handle 102 on the first side 112 and the hoe 110 is secured to the first end 104 of the handle 102 on the second side 114, such that the angle between the first side 112 and the second side 114 is between 90 and 180 degrees, preferably approximately 180 degrees. Typically, the rake 108 and the hoe 110 are secured together before securing to the handle 102. The rake 108 and the hoe 110 are secured together via a weld, however any other suitable securing device can be used without affecting the overall concept of the invention, such as any fastening hardware, glue, etc. The rake 108 and the hoe 110 could also be cast or manufactured as a single device and secured to the first end 104 of the handle 102.

However, the rake 108 and the hoe 110 do not have to be secured together before securing to the first end 104 of the handle 102. The rake 108 can be secured to the first end 104 of the handle 102 independently of the hoe 110. And, the hoe 110 can be secured to the first end 104 of the handle 102 independently of the rake 108. Additionally, the hoe 110 can be secured directly to the rake 108 and then secured to the handle 102. Or, the rake 108 can be secured directly to the hoe 110 and then secured to the handle 102. Further, both the rake 108 and the hoe 110 can be secured to the second end 106 of the handle 102 instead of the first end 104 of the handle 102. The rake 108 and the hoe 110 would be secured on opposite sides of the second end 106 of the handle 102, such that a user can use the hoe 110 and then turn the handle 102, generally 180 degrees to use the rake 108.

The rake 108 and the hoe 110 are typically secured to the handle 102 via a fastener, however any other suitable securing device can be used without affecting the overall concept of the invention, such as any fastening hardware, including screws, set screws, nails, rivets, or glue, etc. Additionally, the rake 108 and the hoe 110 can be secured on opposite ends of the handle 102, such that the rake 108 is secured to the first end 104 and the hoe 110 is secured to the second end 106, or the rake 108 is secured to the second end 106 and the hoe 110 is secured to the first end 104.

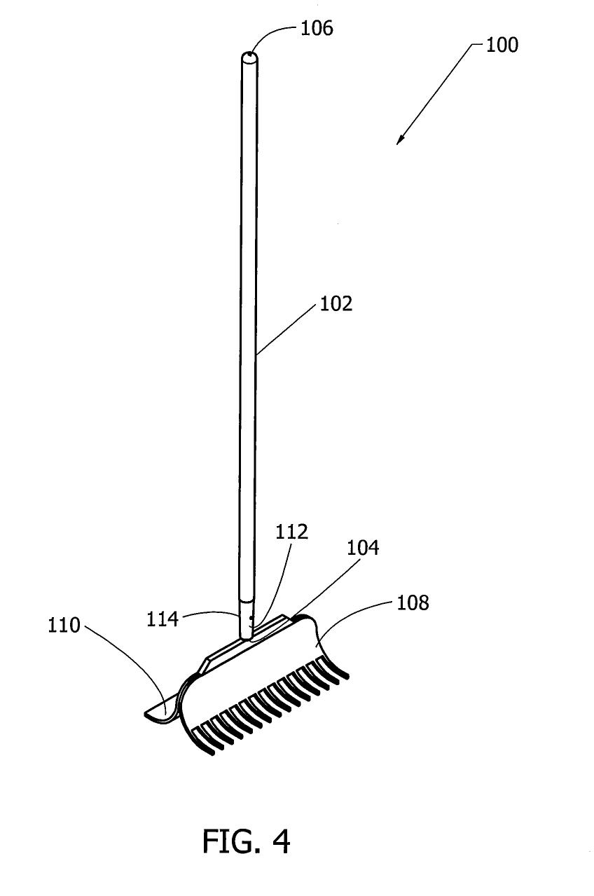

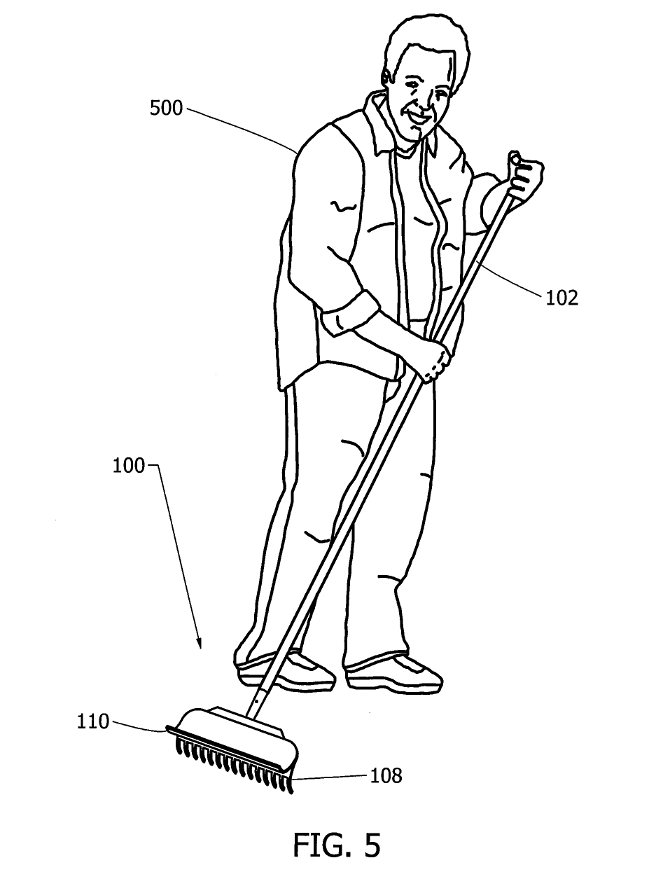

FIG. 4 illustrates the combination tool device 100 in an upright position. In one embodiment of the present invention, the combination tool device 100 is capable of standing upright on its own so that a user can avoid leaning the combination tool device 100 against fragile trench walls, and can avoid having to constantly bend over to pick up the combination tool device 100 when not in use, which can lead to worker fatigue and/or injury. More specifically, the rake 108 and the hoe 110 are positioned on handle 102 such that device 100 is capable of standing upright on its own. For example, the rake 108 is positioned on a first side 112 of the first end 104 of the handle 102, facing outward from the handle. The hoe 110 is positioned on the side 114 of the first end 104 of the handle 102 opposite the rake, also facing outwardly from the handle 102. Thus, when the combination tool device 100 is oriented in an upright position with the second end 106 of the handle 102 pointing upward into the air, the rake 108 and the hoe 110 are positioned to engage the ground and allow the combination tool device 100 to stand upright without support.

FIG. 5 illustrates the combination tool device 100 in use. Once the rake 108 and the hoe 110 are secured to the handle 102, a user 500 grasps the handle 102 and uses the combination tool device 100 to easily and efficiently grade construction and other materials such as soil, mulch and the like. Specifically, the user 500 would turn the combination tool device 100 to the hoe 110 tool and use the combination tool device 100 to push and pull the materials used in construction. Then, the user 500 would turn the handle 102 of the combination tool device 100, generally 180 degrees to engage the rake 108 with the materials being moved. The user 500 would then use the rake 108 to smooth the materials to complete the grading job. When not in use, the combination tool device 100 can be stood upright without support, using the rake 108 and the hoe 110 as a stand. This allows a user 500 to avoid leaning the combination tool device 100 against fragile trench walls, and avoids having a user 500 constantly bend over and pick up the combination tool device 100 when needed.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A grading device, comprising:
a handle having a first end and a second end, wherein said first end further comprises a first side and a second side;
a rake secured to the first end of the handle on the first side; and
a hoe secured to the first end of the handle on the second side.

2. The device of claim 1, wherein the hoe is an elongated hoe that is substantially equal in length to the rake.

3. The device of claim 1, wherein the hoe is a come-along tool.

4. The device of claim 1, wherein the rake is a steel-forked rake.

5. The device of claim 1, wherein the rake and the hoe are secured together and then secured to the first end of the handle.

6. The device of claim 5, wherein the rake and the hoe are secured together via a weld.

7. The device of claim 6, wherein the rake and the hoe are secured to the handle via a set screw.

8. The device of claim 7, wherein the rake and the hoe are positioned on the handle such that the device is capable of standing upright on its own.

9. The device of claim 1, wherein the handle is made of aluminum.

10. The device of claim 1, wherein the handle is an extended length handle.

11. A combination tool device, comprising:
a handle having a first end and a second end;
a rake; and
a come-along tool,
wherein the rake and the come-along tool are secured together and attached to the first end of the handle.

12. The combination tool device of claim 11, wherein the rake and the come-along tool are secured together via a weld.

13. The combination device of claim 12, wherein the rake and the come-along tool are attached to the first end of the handle via a fastener.

14. The combination device of claim 13, wherein the rake and the hoe are secured together such that the rake and the come-along tool are on opposite sides of the first end of the handle.

15. The combination device of claim 11, wherein the handle is made of aluminum.

16. A combination tool device, comprising:
a handle;
a rake; and
a hoe,
wherein the rake and the hoe are secured together and attached to the handle.

17. The combination tool device of claim 16, wherein the rake and the hoe are secured together such that the rake and the hoe are on opposite sides of the handle.

18. The combination tool device of claim 17, wherein the rake and the hoe are welded together.

19. The combination device of claim 16, wherein the handle comprise a first end and a second end.

20. The combination device of claim 19, wherein the rake and the hoe are secured to the first end of the handle.
